(19) United States
(12) Patent Application Publication
(10) Pub. No.: US 2025/0108581 A1
(43) Pub. Date: Apr. 3, 2025

(54) CONSTRAINED LAYER DAMPER FOR REDUCING GLOBAL VIBRATIONS OF TUBULAR STRUCTURES

(71) Applicant: University of Kansas, Lawrence, KS (US)

(72) Inventors: Jian Li, Lawrence, KS (US); Mona Shaheen, Lawrence, KS (US); Caroline Bennett, Lawrence, KS (US); William Collins, Lawrence, KS (US)

(21) Appl. No.: 18/830,006

(22) Filed: Sep. 10, 2024

Related U.S. Application Data
(60) Provisional application No. 63/537,582, filed on Sep. 11, 2023.

(51) Int. Cl. B32B 1/08; B32B 15/06; B32B 25/14; F16F 7/08; F21V 21/10

(52) U.S. Cl. CPC B32B 1/08; B32B 15/06; B32B 25/14; F16F 7/087; F21V 21/10; B32B 2250/03; B32B 2597/00; F16F 2224/025

(57) ABSTRACT

Various examples are provided related to reducing global vibrations of tubular structures. In one example, a structure includes a tubular base structure extending along a longitudinal axis; a viscoelastic (VE) layer disposed on and distributed about the tubular base structure; and a constraining layer including a plurality of sections distributed about the tubular base structure and disposed on the VE layer, each section extending along the longitudinal axis of the tubular base structure and separated from an adjacent section by a longitudinal slit extending over an entire length of the section. In another example, a method includes disposing a VE layer on a tubular base structure extending along a longitudinal axis, the VE layer distributed about the tubular base structure; and disposing a constraining layer on the VE layer, the constraining layer including a plurality of sections distributed about the longitudinal axis of the tubular base structure.

### CROSS REFERENCE TO RELATED APPLICATIONS

This application claims priority to, and benefit of, U.S. Provisional Application entitled “Constrained Layer Damper for Reducing Global Vibrations of Tubular Structures” having Ser. No. 63/537,582, filed Sep. 11, 2023, which is hereby incorporated by reference in its entirety.

### BACKGROUND

High mast illumination poles (HMIPs) are tall, slender structures usually installed on highways where high illumination is needed. The HMIPs system comprises a light assembly and a lowering device mounted on a flexible cantilever, typically 100 to 120 feet tall. Despite their simple design and compliance with the code, these HMIPs are known to have low inherent damping, and some have previously experienced fatigue cracks and failed due to excessive vibrations under the wind. The failure of these HMIPs imposes a high risk of wind-induced hazard due to their locations. Therefore, various vibration mitigation strategies have been investigated to reduce the excessive vibrations of these HMIPs depending on the mechanism behind the vibrations.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B illustrate an example of a rectangular cantilever beam without and with shear deformation in a viscoelastic (VE) layer, in accordance with various embodiments of the present disclosure.

FIGS. 2A and 2B illustrate examples of shear deformation in the VE layer with continuous and divided constraining layers, in accordance with various embodiments of the present disclosure.

FIG. 3 illustrates examples of rectangular beam and cylindrical section mesh, in accordance with various embodiments of the present disclosure.

FIG. 4 illustrates an example of evaluation results for a rectangular cantilever beam, in accordance with various embodiments of the present disclosure.

FIGS. 5A and 5B illustrate examples of a tubular cantilever beam with conventional and proposed CLD with slits in the constraining layer, in accordance with various embodiments of the present disclosure.

FIGS. 6-8 illustrate examples of evaluation results for a tubular cantilever beam, in accordance with various embodiments of the present disclosure.

FIG. 9 illustrates an example of a tubular cantilever beam with the proposed CLD with slits in the constraining and VE layers, in accordance with various embodiments of the present disclosure.

FIG. 10 illustrates examples of free vibration responses for different VE layer thicknesses, in accordance with various embodiments of the present disclosure.

FIG. 11 illustrates examples of a tubular base structure with different CLD area coverages, in accordance with various embodiments of the present disclosure.

FIG. 12 illustrates examples of free vibration responses for the different CLD area coverages, in accordance with various embodiments of the present disclosure.

FIG. 13 illustrates examples of the free vibration displacement response for a HMIP model with different VE layer thicknesses, in accordance with various embodiments of the present disclosure.

FIG. 14 illustrates examples of free vibration displacement response for the HMIP model with varying constraining layer thicknesses, in accordance with various embodiments of the present disclosure.

FIGS. 15 and 16 illustrate examples of CLD applied to a HMIP, in accordance with various embodiments of the present disclosure.

FIG. 17 illustrates examples of free vibration displacement response for the proposed CLD starting from the base and from about the hand hole, in accordance with various embodiments of the present disclosure.

### DETAILED DESCRIPTION

Disclosed herein are various examples related to reducing global vibrations of tubular structures. The vibration reduction can be provided by a constrained layer damper. Reference will now be made in detail to the description of the embodiments as illustrated in the drawings, wherein like reference numbers indicate like parts throughout the several views.

Aerodynamic and structural dampers can be used to reduce wind-induced vibrations on slender light poles, depending on the cause of the vibration. Aerodynamic dampers modify the surface and geometry of the original structure. As a result, they alter the aerodynamic properties of the system and disturb the formation of vortices. Hence, this type of damper can be used to dampen vibration caused by vortex shedding. For example, aerodynamic dampers such as ribbon retrofit, helical strakes, perforated shrouds, and surface roughness can be installed on a HMIP to reduce vortex-induced vibration (VIV). The aerodynamic dampers can be used to retrofit the HMIP because they do not interfere with the HMIP's lowering device, are cost-effective, and are easy to install.

Structural dampers, on the other hand, function differently than aerodynamic dampers, as they reduce vibration by increasing the damping capability of the structure. Various structural dampers have been installed on light poles, such as tuned mass dampers, Stockbridge dampers, and impact dampers. The tuned-mass damper can be designed to vibrate at specific natural frequencies of the system and is usually installed on high-rise buildings and slender towers. When the structure oscillates, the tuned-mass damper is excited and vibrates in opposition to the magnitude of the structure's vibration; consequently, it reduces unwanted vibrations. A Stockbridge damper has two masses attached at the end of a flexible shaft and can be installed inside or outside the structure. The Stockbridge damper is generally designed at a frequency close to the structure's second or third natural frequency, preventing lock-in. The Stockbridge dampers were installed on the exterior of existing light poles in New Jersey and effectively reduced VIV.

Impact dampers come in various types, including ball impact damper, tube damper, rod in a canister damper, and chain damper. They can be used to reduce vortex or buffeting-induced vibration. Impact dampers dissipate energy through exchanging momentum and collision impact. Impact dampers can be modeled as a spring with viscous damping. The ball impact damper is a freely moving mass inside a container. This damper is typically installed on top of a light pole to reduce the amplitude of first-mode vibration. A chain damper can be a simple and cost-effective way to reduce buffeting-induced vibration on tall structures. Chain dampers are made of a chain covered in rubber hanging from the top of the structure and freely moving within it, or they can be located inside a container and attached to the main structure. When the structure vibrates, the chain collides with the container's walls, resulting in alternating impulses that occur twice per cycle and dissipate the vibration's amplitude. The effectiveness of the chain damper was tested experimentally on a full-scale 45 ft light pole and proved to increase the structure's damping.

A tube damper typically serves to control the second mode vibration of light pole structures. This damper can be made of cables with smaller strands inserted into a plastic tube. The tube damper length is usually 80% of the pole's height and can be installed through the handhole of the pole. For example, the tube damper can be installed inside an aluminum light pole and can result in an increase in the light pole damping from about 0.18% to about 0.83%. Regarding the rod in a canister damper, it can be designed to reduce higher-model vibrations typically induced by vortex shedding. It is generally installed on a height close to ⅔ of the pole, and it is ideal for retrofitting existing light poles because it can be installed inside or outside the pole.

However, the vibration mitigation devices found in the literature to reduce buffeting-induced vibration are not suitable for the HMIP tubular structures due to several practical constraints. First, the HMIP structures are 100 ft tall, and the damper must be installed in situ. Second, the HMIP is equipped with a lowering device for installing and replacing lights at the top of the pole, so the damper installation and operation cannot interfere with the lowering device. Third, the damper must be low-cost to be economically feasible. As a result, the previously reviewed dampers, such as the ball damper, chain damper, and tube damper, will either be too difficult to be installed at the top of the pole or interfere with the lowering device. Therefore, a passive structural damper called a constrained layer damper (CLD) offers advantages to reducing the HMIP vibration from buffeting as it can increase the damping of the HMIP without interfering with the lower device and is relatively easy to install at the lower portion of the HMIP.

### Constrained Layer Damper (CLD)

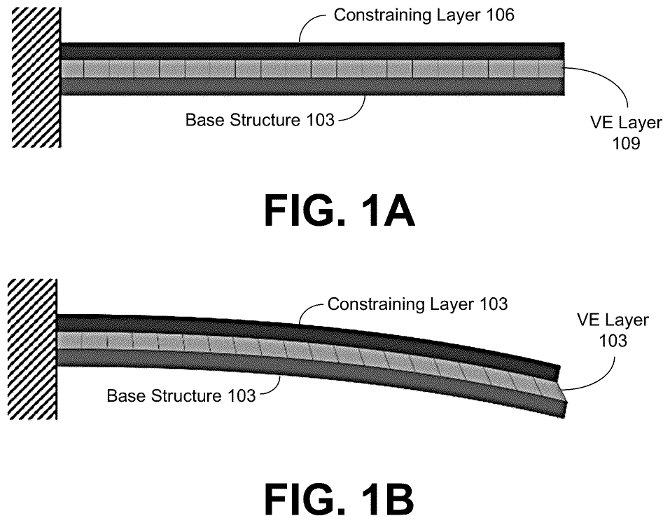

A CLD can be made of a viscoelastic (VE) material confined between the base structure 103 and a stiff constraining layer 106. FIG. 1A illustrates an example of a rectangular cantilever beam with an undeformed VE layer 109. When the structure vibrates in bending, the VE material deforms in shear due to relative displacement between the VE material and the base structure 103. FIG. 1B illustrates an example of the rectangular cantilever beam with shear deformation in the VE layer 109 under bending of the beam. The shear deformation occurs in the VE material because of the separation of the neutral axes between the base structure and the constraining layer, which allows them to move differently in the longitudinal direction. As a result, the developed shear strain in the VE layer will reduce the vibration amplitude because of the VE material's ability to store shear strain energy and dissipate it via hysteresis when the beam deforms in bending.

The CLD has been widely used in mechanical and aerospace structures to efficiently reduce noise and vibrations. CLD has shown effective damping when applied to rectangular cantilever beams and plates. However, CLD has not been installed on tapered, slender tubular structures such as the HMIP. Therefore, the effectiveness of a CLD in reducing vibration caused by wind-induced buffeting on HMIP structures is investigated here. CLD can also be effectively applied to other tubular structures.

Viscoelastic Material. The middle layer of the CLD is made of a VE material, which exhibits elastic solid and viscous liquid properties. When a material is purely elastic, all of the energy stored during the loading phase is recovered upon unloading, and the material returns to its original configuration. On the other hand, a viscous material deforms under applied load, and the stored energy does not recover after the load is removed.

The behavior of viscoelastic materials lies between the elastic and viscous extremes. Because viscoelastic materials are polymers with long chain molecules, they can convert mechanical energy into heat when deformed. Consequently, some strain energy is recovered when the load is removed, while the rest is dissipated through heat. The rate of shear energy loss in terms of thermal energy determines the viscoelastic material's performance in reducing vibration. The damping in viscoelastic materials can be expressed by the phase shift between maximums of shear stress and shear strain, which has a maximum value of 90 degrees. The greater the phase angle between the stress and strain during the same cycle, the more the viscoelastic material can reduce undesired vibration.

A complex modulus describes viscoelastic material behavior, a function of temperature and frequency. The complex modulus describes the stiffness and damping properties of the material, and it is written as:

$${E}^{*} = {E}_{1} + {E}_{2} i = E ( 1 + i η ) \qquad ( 1 )$$

$${G}^{*} = {G}_{1} + {G}_{2} i = G ( 1 + i η ) \qquad ( 2 )$$

where E* and G* are the complex elastic and shear modulus. The real part of this complex modulus refers to the material's elastic behavior and defines the stiffness. The imaginary part refers to the material's viscous behavior and represents its ability to dissipate energy, which is associated with the loss factor (n).

Proposed CLD Design. A new design of CLD for cylindrical sections is proposed by adding multiple longitudinal slits in the constraining layer instead of wrapping it as one piece around the circular section. This proposed method makes the CLD work effectively as a viscoelastic damper when the structure deforms in bending, which will be described in more detail. The new method overcomes challenges found using traditional CLD in this application. A numerical investigation illustrates the efficiency of applying the CLD on tubular cantilever structures.

Three different models were created in Abaqus CAE, version 6.24. The efficiency of the CLD for vibration mitigation was assessed based on the damping ratio estimated from the simulated free vibration response using the logarithmic decrement method. First, a rectangular cantilever beam model was used to assess the damping capabilities of different VE materials. Then, a prismatic tubular cantilever beam model was used to compare the behavior of the conventional CLD and the proposed CLD. In the prismatic tubular cantilever beam, the effect of changing several design parameters of the CLD on its damping performance was investigated, including the thicknesses of the VE and constraining layers and the percent coverage in the longitudinal direction. Subsequently, the proposed CLD was applied to a full-scale HMIP structure numerically. A parametric study was carried out on the effect of changing the VE layer and the constraining layer thickness to select optimal parameters for the CLD. A practical adjustment was then made to the CLD to avoid covering the area of the handhole of the HMIP, and the impact of the practical adjustment was assessed. Finally, to better understand the practical implication of the improvement in damping ratio, the study theoretically evaluated the level of reduction of the steady-state response when the HMIP is subject to resonance at the first model under buffeting-induced wind load.

Proposed CLD vs. Conventional CLD. The most common applications of CLD are on rectangular beams and plates. These studies have clearly demonstrated the CLD's ability to dampen undesired vibrations efficiently. On cylindrical sections, the effect of applying different pieces of CLD has been experimentally tested on the damping ratio for high-stiffness, thin cylindrical shells. The application of CLD to a thin cylindrical shell was investigated by varying the number of CLD pieces, the size of each CLD piece, and covering a CLD ring at various positions. The size of each CLD piece was determined by changing the length-width ratio of the CLD piece along the length or circumferential direction of the shell. The study found that the CLD increased the damping of the thin cylindrical shell, mostly when the CLD piece was applied along the circumferential direction with a length-width ratio equal to 1:6.

Other studies used conventional CLD made of continuous constraining and viscoelastic layers wrapped around tubular structures. For instance, the application of CLD on highway bridge columns was numerically studied with circular sections. The study evaluated the effect of varying the CLD coverage and the VE layer thickness on increasing the damping of the column. It was found that a 0.1 in. VE layer thickness covering 40% of the column and anchored to the fixed base reduced the out-of-plane and in-plane frequency response ratios by 14% and 11%, respectively. The study also showed that the VE layer was more effective when covering 20% to 80% of the column height. Another study examined the application of CLD to reduce the vibration of a cylindrical composite structure with low vibration frequency. The study considered different scenarios of applying only the VE layer and CLD to the cylinder's inner or outer circumference and adding shear webs to the cylinder, and studied the effect of covering the shear webs with CLD. Among all the different models, the study found that the maximum damping values were achieved when the CLD was applied inside and outside the cylinder's circumference. Additionally, it was found that adding a one-shear web covered with CLD along with covering the inner and outer circumference with CLD will produce the highest the obtained damping ratio.

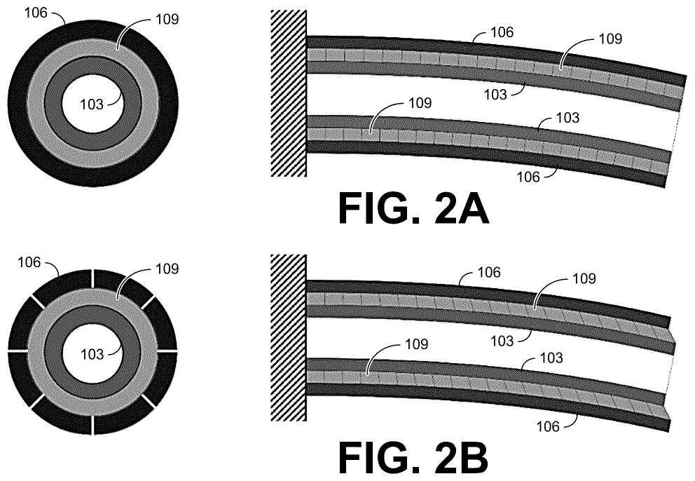

Now, consider applying CLD to slender tubular cantilever structures with a low-frequency vibration. FIGS. 2A and 2B illustrate examples of shear deformation in the VE layer 109 between the base structure 103 and constraining layer 106 of a tubular section. The traditional CLD of FIG. 2A comprises a continuous constraining layer 106. Therefore, the base structure and the constraining layer will share the same neutral axis in tubular sections. As a result, when the structure vibrates in bending, the base structure 103 and the constraining layer 106 will undergo the same bending deformation, as illustrated in FIG. 2A. Consequently, this results in a negligible shear deformation in the VE layer and makes the damper ineffective in dampening vibrations.

To overcome this challenge, the proposed CLD incorporates longitudinal slits (e.g., eight longitudinal slits) in the constraining layer 106, dividing the constraining layer 106 into pieces (e.g., eight pieces as shown in FIG. 2B) that are continuous in the longitudinal direction of the cylinder. The advantage of this new approach is that each piece is independent of the other; therefore, the constraining layer neutral axis no longer overlaps with the base structure. As a result, this new approach allows the viscoelastic layer to develop shear deformation when the structure vibrates in bending, as shown in FIG. 2B, due to the relative displacement between the constraining layer and the base structure. The proposed method allows the full engagement of the viscoelastic layer in shear, leading to higher damping. Moreover, implementing the proposed method in practice is easier than having one piece of the constraining layer covering the whole tubular structure. Detailed analysis and results validate the effectiveness of the proposed CLD design, in addition to assessing the damping improvement for different VE materials and the effect of changing different CLD parameters on the damping improvement in the tubular section.

Numerical Modeling-Material Properties. The base structure 103 in each finite element (FE) model was made of steel. Other materials such as, e.g., aluminum, copper, or other types of metal can also be utilized. The constraining layer 106 was made of steel in the rectangular cantilever beam model and the prismatic tubular cantilever beam. However, in the HMIP model, the constraining layer 106 was made of carbon fiber-reinforced polymer (CFRP). Other types of material with high stiffness to provide adequate constraint to the VE layer may also be applicable. Regarding the VE material, a comparison of three VE materials will be made in the rectangular cantilever beam section to choose the material with the highest damping capability for the cylindrical sections.

The nonlinear time-dependent behavior of the VE material was simulated in Abaqus using hyperelastic and viscoelastic properties. The hyperelastic properties illustrate the rubber's instantaneous elastic modulus undergoing significant deformation. It can be defined in Abaqus by providing the strain-energy potential coefficients or by fitting data from uniaxial, biaxial, planner, and volumetric tension and compression tests. The material's test data is fitted to an Abaqus-defined strain-energy potential, which includes the Arruda-Boyce, Marlow, Ogden, Polynomial, Van der Waals, Mooney-Rivlin, Reduced Polynomial, Neo-Hookean, and Yeoh models.

The viscoelastic properties define the rubber's long-term viscous response. In Abaqus, the Prony series is used to model the stress relaxation response in viscoelastic materials, or it can be defined by fitting shear test data to the Prony series parameters. The shear relaxation Prony series for a generalized Maxwell model is given by:

$$G ( t ) = {G}_{∞} + {\sum }_{i = 1}^{N} {G}_{i} {e}^{- t / {τ}_{i}} \qquad ( 3 )$$

where G_{∞} is the long-term shear modulus of a material when it is completely relaxed. The shear modulus of the ith element is given by Gᵢ, and the relaxation time τᵢ is the ratio of viscosity (ηᵢ) over Gᵢ.

The initial relaxation modulus G₀=G_{∞}+Σᵢ₌₁^{N}Gᵢ. Therefore,

$$G ( t ) = {G}_{0} - {\sum }_{i = 1}^{N} {G}_{i} + {\sum }_{i = 1}^{N} {G}_{i} {e}^{- \frac{t}{{τ}_{i}}} = {G}_{0} - {\sum }_{i = 1}^{N} {G}_{i} ( 1 - {e}^{- \frac{t}{{τ}_{i}}} ) \qquad ( 4 )$$

In Abaqus, the dimensionless shear relaxation modulus, g_{R}(t), is given as G(t)/G₀. Thus,

$${g}_{R} ( t ) = 1 - {\sum }_{i = 1}^{N} {g}_{i} ( 1 - {e}^{- \frac{t}{{τ}_{i}}} ) \qquad ( 5 )$$

where gᵢ is the dimensionless Prony series coefficient, which is equal to G(t)/G₀.

Numerical Modeling—Meshing and Tie Constraints. The base structure 103 and the constraining layer 106 were modeled using the eight-node linear brick element (C3D8). VE and rubberlike materials have a high Poisson's ratio close to 0.5 because they are considered almost incompressible. Therefore, a hybrid deformable C3D8H element was used for the VE layer. A hybrid element adds a degree of freedom to measure the stress considering there is no change in the volume of the material under load. The C3D8 elements are eight-node, 3D-solid elements with 24 degrees of freedom in terms of displacement. However, the C3D8 element might experience shear locking and extra stiffness caused by the Poisson's effect in bending. Therefore, incompatible modes elements (C3D81) and (C3D8IH) with an extra 13 internal degrees of freedom were modeled, and the difference in terms of free vibration response between the two mesh types is evaluated.

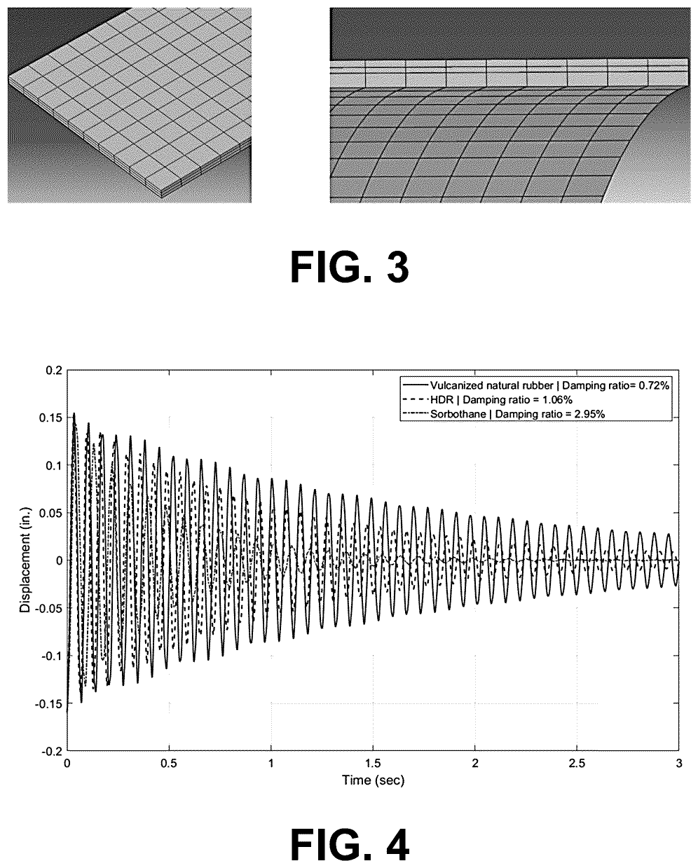

Tie constraints were used to connect the various surfaces of the beam and CLD parts. Therefore, the master surfaces were modeled as the base structure's (rectangular beam) top or (the tubular section) outer surface and the constraining layer's bottom or inner surface. The VE material surfaces were modeled as slave surfaces, with the bottom or inner surface tied to the base structure and the top or outer surface tied to the constraining layer. In addition, the nodes were aligned in the three CLD sections. FIG. 3 shows examples of a rectangular beam mesh (left) and a cross section in the cylindrical section mesh (right).

Numerical Modeling-Boundary Conditions and Loading. All translational and rotational degrees of freedom at the base of the cantilever beams were constrained to provide fixed boundary conditions. The constraining layer 106 was anchored at the base using the same boundary conditions as the fixed base. Anchoring the constraining layer 106 to the fixed support will lead to shear strain accumulation towards the free end of the VE material, thus maximizing the effectiveness of the CLD.

The load was applied as a point load at the structure's free end to cause an initial displacement equal to 1% of the structure's total height to simulate the level of wind-induced displacement captured from the videos of the HMIP. The point load was applied to the middle node of the rectangular beam. Similarly, the load was applied to a reference node at the top of the HMIP. The reference node was located in the middle of the circular section, and the circumferential surface was tied to the reference node using coupling constraint without constraining any of the nodes' degrees of freedom.

Numerical Modeling-Implicit Dynamic Analysis. At first, a static step was applied to cause the initial displacement and then deactivated for the dynamic implicit step. The direct integration dynamic implicit step in Abaqus CAE was used to simulate the transient free vibration response caused by the applied initial displacement. The time increment value in the implicit step was set to be equal to or less than 10% of the typical period of vibration, which is the first mode's period. The time increment value ensured that no artificial damping was added from the solver to the simulated displacement time history. The dynamic implicit step used the Hilbert-Hughes-Taylor operator, an extension of the trapezoidal rule. The integration matrix was inverted, and a set of simultaneous nonlinear dynamic equilibrium equations was solved at each time increment iteratively using Newton's method.

### Rectangular Cantilever Beam

A rectangular cantilever beam was used as a baseline to evaluate the efficiency of three viscoelastic materials in reducing the beam's vibration amplitude. The damping ratio was estimated using the logarithmic decrement method applied to the displacement free vibration time history. The material with the highest damping ratio was chosen for the rest of the study.

Geometry and Material Properties. The dimensions of the beam are 2 in.×15.5 in.×0.08 in. The VE layer 109 and the constraining layer 106, both with thicknesses of 0.04 in. and 0.08 in., covered the entire length of the rectangular beam. In the rectangular cantilever beam model, the thickness of the constraining layer 106 was set to be the same as the base structure 103 to improve the efficiency of the CLD by maximizing the shear strain distribution in the VE material. Table 1 shows the material properties of the steel used for the beam (base structure 103) and the constraining layer 106.

TABLE 1
Material Properties of Steel.

| Density (lb/in³) | Young's modulus (ksi) | Poisson's ratio |
|---|---|---|
| 0.284 | 29,000 | 0.3 |

The chosen VE materials for the rectangular cantilever beam model were based on previously used VE materials in CLD and available data in the literature for material input in Abaqus. The modeled three VE materials include vulcanized natural rubber, high-damping rubber (HDR), and Sorbothane® viscoelastic polymer. Other types of viscoelastic materials may also be applicable.

Vulcanized Natural Rubber. Natural rubber is a material with a low damping coefficient. Vulcanizing natural rubber with sulfur improves the material's behavior by increasing its tensile strength and resistance to swelling and abrasion, and it becomes more elastic over a wide temperature range. The hyperelastic behavior of the vulcanized rubber was defined using the Yeoh model strain-energy function based on nominal stress and nominal strain data from uniaxial, planar, and biaxial tests. The Yeoh model is a third-degree polynomial strain-energy function and can be written as:

$$U = {\sum }_{i = 1}^{3} ( {C}_{i 0} ( {( {\overline{I}}_{1} - 3 )}^{l} ) + {\sum }_{i = 1}^{3} \frac{1}{{D}_{i}} {( {J}_{el} - 1 )}^{2 i} \qquad ( 6 )$$

where the shear modulus is described in Cᵢ₀, and the initial bulk modulus K₀ is equal to 2/D₁, Dᵢ is equal to zero for incompressible materials. I₁ is the deviatoric strain's first invariant, and the elastic volumetric strain of the material

$${J}_{e l} = \frac{{λ}_{1} {λ}_{2} {λ}_{3}}{{V}_{r}} .$$

The Prony series for the shear relaxation data represents the vulcanized rubber viscoelasticity. Table 2 shows the hyperelastic properties of the vulcanized natural rubber. Table 3 shows the vulcanized natural rubber viscoelastic properties.

TABLE 2
Yeoh Hyperelastic Model Coefficients for
Vulcanized Natural Rubber.

| C₁₀ | C₂₀ | C₃₀ | D₁ | | |
|---|---|---|---|---|---|
| (psi) | (psi) | (psi) | (psi⁻¹) | D2 (psi⁻¹) | D3 (psi⁻¹) |
| 46.412 | 0.00643 | 0.01878 | 1.5057 × 10⁻⁵ | 5.9856 × 10⁻⁷ | −1.2369 × 10⁻⁷ |

TABLE 3
Prony Series Parameter
for Vulcanized Natural Rubber.

| g₁ | g₂ | τ₁ | τ₂ |
|---|---|---|---|
| 0.094 | 0.094 | 0.09 | 0.045 |

High-Damping Rubber (HDR). Rubber has been widely used in the seismic protection of structures throughout VE dampers and base isolation systems. The need to increase the damping in natural rubber led to HDR production by adding fine carbon black, oils or polymers, and other additives to the natural rubber. The Ogden model strain-energy function was used to define the HDR hyperelastic material behavior base on uniaxial test data, which can be written in this form:

$$U = {\sum }_{i = 1}^{3} \frac{2 {μ}_{i}}{{α}_{i}^{2}} ( {\overline{λ}}_{1}^{{α}_{i}} + {\overline{λ}}_{2}^{{α}_{i}} + {\overline{λ}}_{3}^{{α}_{i}} - 3 ) + {\sum }_{i = 1}^{3} \frac{1}{{D}_{i}} {( {J}_{el} - 1 )}^{2 i} \qquad ( 7 )$$

where αᵢ is the dimensionless non-linearity constant, the initial shear modulus (μ) given by Σᵢ₌₁³μᵢ, and the initial bulk modulus K₀ equal to 2/D₁, Dᵢ is equal to zero for incompressible materials. The deviatoric stretches

$${\overline{λ}}_{i} = {J}^{- \frac{1}{3}} {λ}_{i} ,$$

in which λᵢ are the principal stretches, and the elastic volumetric strain of the material

$${J}_{e l} = \frac{{λ}_{1} {λ}_{2} {λ}_{3}}{{V}_{r}} .$$

The viscoelastic behavior was defined using the Prony series parameters, which are time-dependent constants based on a shear relaxation test. The viscoelastic and hyperelastic properties of HDR are provided in Table 4 and Table 5, respectively.

TABLE 4
Prony Series Parameter for HDR.

| gᵢ × 10⁻² | τᵢ |
|---|---|
| 9.88 | 0.01 |
| −5.36 | 0.10 |
| 25.19 | 1 |
| 4.02 | 10 |
| 16.53 | 100 |

TABLE 5
Uniaxial Test Data for HDR.

| Stress (psi) | Strain (%) |
|---|---|
| −411.473 | −42 |
| −242.794 | −30 |
| −140.832 | −20 |
| −91.519 | −15 |
| −38.5801 | −10 |
| 0 | 0 |
| 353.8927 | 100 |
| 706.3351 | 200 |
| 1138.548 | 300 |
| 1699.845 | 400 |
| 2313.356 | 500 |

Polyurethane Viscoelastic Material. The Sorbothane® VE polymer used in this section is made of polyurethane material. This material has unique properties such as long fatigue life, low creep coefficient, shock absorption for millions of cycles, and high damping coefficient over a wide temperature range of −20 F to 160 F (Sorbothane Inc., 2022). The Sorbothane weight density is 0.048 lb/in³. The VE polymer's instantaneous elastic modulus was calculated using hyperelastic properties and the Ogden model strain-energy function described in Equation (7). The hyperelasticity is defined in Abaqus CAE using uniaxial test data, which is provided in Table 6. Furthermore, the viscoelastic properties using the Prony series represent the long-term viscous response, which can be found in Table 7.

TABLE 6
Uniaxial Test Data for Sorbothane ® VE material.

| Stress (psi) | Strain |
|---|---|
| 7 | 0.1 |
| 11 | 0.15 |
| 19 | 0.2 |
| 24 | 0.25 |
| 48 | 0.3 |
| 69 | 0.4 |

TABLE 7
Prony Series Parameter for Sorbothane ® VE material.

| g₁ | g₂ | τ₁ | τ₂ |
|---|---|---|---|
| 0.6281 | 0.1908 | 0.0202 | 0.1819 |

Material and Element Type Evaluation—VE Materials Damping Ratio. The VE material evaluation was based on the displacement's free vibration response obtained from the implicit step in Abaqus. The logarithmic decrement method was used to get the damping ratios of the three VE materials. FIG. 4 shows examples of the free vibration displacement response for the rectangular cantilever beam with three different VE materials. The vulcanized natural rubber had the lowest damping ratio, estimated to be 0.72%. The HDR material performed better than the vulcanized natural rubber in reducing the vibration amplitude, and its damping ratio was estimated to be around 1.06%. Regarding the Sorbothane® VE material, the material was able to damp out the vibrations quicker than the vulcanized natural rubber and the HDR. The damping ratio of the Sorbothane® VE material was around 2.95%. Table 8 summarizes the damping ratios obtained from the three VE materials. Because the Sorbothane® material had the highest damping performance among the vulcanized natural rubber and HDR, it was chosen as the VE material for this examination.

TABLE 8
Damping Ratio for the Three Different VE Materials.

| Material | Damping ratio (%) |
|---|---|
| Vulcanizing natural rubber | 0.72 |
| High-damping rubber | 1.06 |
| Sorbothane | 2.95 |

### Tubular Cantilever Beam

A discussion of the conventional and proposed CLD on a prismatic tubular cantilever beam and numerical simulations are provided to show the effectiveness of adding multiple longitudinal slits to the constraining layer. A parametric study was conducted to see the effect of changing a few parameters on reducing the free vibration response of the prismatic tubular cantilever beam. To this end, the VE material's thickness was adjusted to understand better the effect of changing the VE layer thickness on the damping ratio. In addition, the effect of changing the CLD coverage on vibration reduction was investigated for practical reasons because it is not practical to cover the entire structure in the HMIP model using the CLD.

Geometry and Material Properties. Consider a hollow cantilever tube that is 195 in. long, has a 3 in. inner diameter with a thickness of 0.16 in., and is made of galvanized steel. Other materials such as, e.g., aluminum, copper, or other types of metal can also be utilized. The constraining layer was made of a steel sheet with a thickness of 0.0625 in. For the VE layer thickness, (2012) recommended a 0.1 in. minimum thickness for practical applications of CLD. Therefore, an initial 0.1 in. VE layer made of Sorbothane® was used, and the effects of increasing the VE material thickness and varying the length of the CLD are studied later in this section. The material properties of steel can be found in Table 1. The hyperelastic and viscoelastic properties of Sorbothane® are provided in Table 6 and Table 7, respectively.

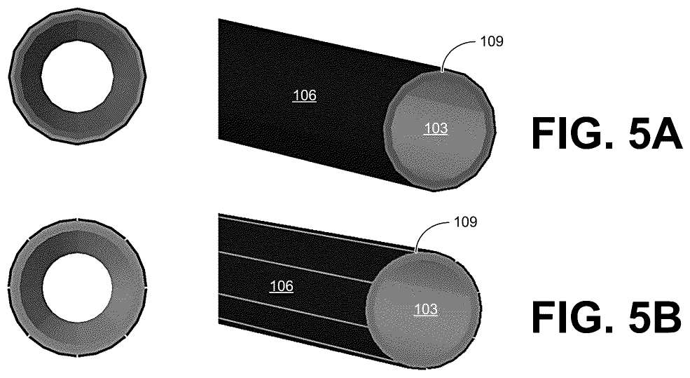

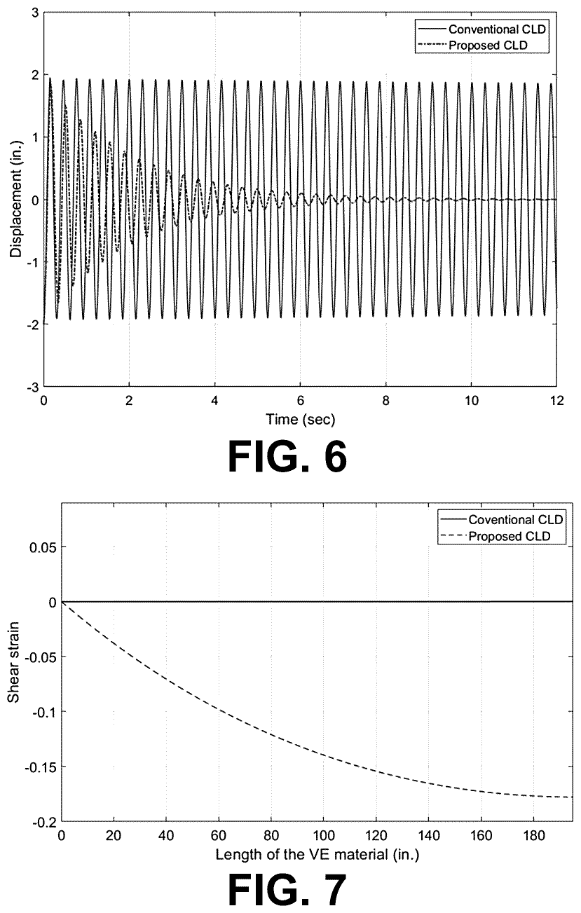

Shear Strain Distribution in the Conventional and Proposed CLDs. FIGS. 5A and 5B illustrate examples of conventional CLD and the proposed CLD with slits in the constraining layer 106, respectively. The conventional CLD was implemented in Abaqus CAE by wrapping a continuous constraining layer 106 around the tubular base structure 103, as shown in FIG. 5A. FIG. 6 shows an example of the free vibration displacement response for the conventional CLD vs. the newly proposed CLD. The transient free vibration response from the implicit step showed virtually no damping. To understand the mechanical reason for this phenomenon, the shear strain distribution along the VE material was investigated using a Visco step. The Abaqus CAE Visco step is a quasi-static stress analysis used to analyze the response of time-dependent materials such as VE materials. Due to the overlapping of neutral axes for the base structure 103 and the constraining layer 106 in the conventional CLD, both the base structure 103 and the constraining layer 106 undergo the same bending deformation, resulting in negligible shear strain along the VE material layer 106 as can be seen in FIG. 7, which shows the shear strain distribution in the conventional CLD vs. the proposed CL. For this reason, the conventional CLD adds negligible damping when applied to tubular structures.

The new CLD design is introduced to overcome this challenge by adding, e.g., eight 0.04 in. wide slits to the constraining layer in the longitudinal direction, as in FIG. 5B. This newly proposed CLD design splits the constraining layer into eight different pieces. Each piece of the constraining layer 106 will act independently from others; hence they no longer share the same neutral axis with the base structure. Consequently, the VE material will fully engage and deform in shear when the cylindrical section undergoes bending deformation. In particular, the VE material's shear strain accumulates towards the free end, as shown in FIG. 7. The newly proposed CLD effectively reduces the vibration amplitude on the tubular beam, as seen in FIG. 6. The estimated damping ratio from the free vibration response is 2.94%.

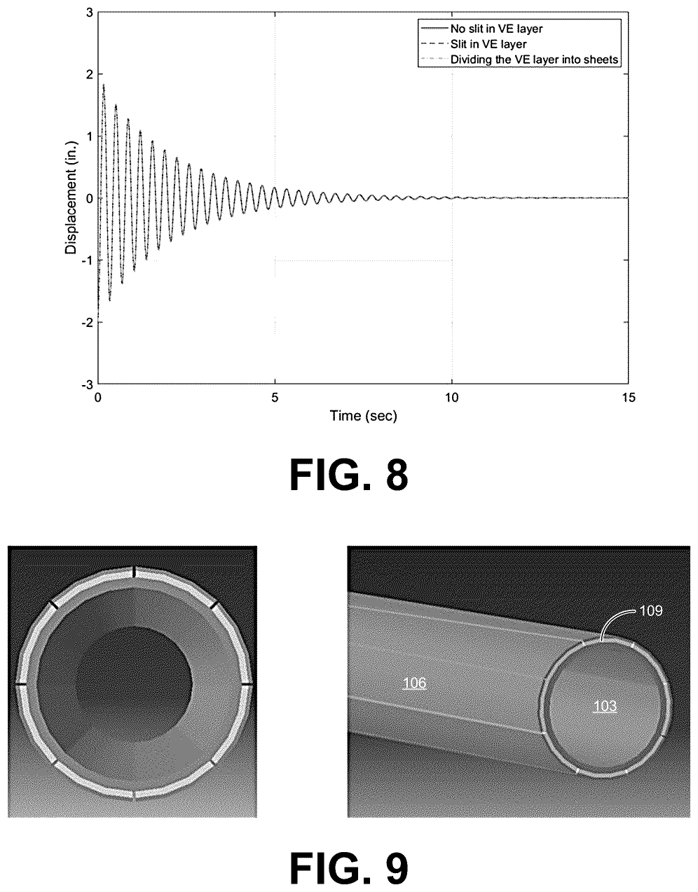

In addition to adding slits to the constraining layer 106, the study also investigated the effect of adding slits to the VE layer 109 to divide the VE layer 109 into separate sheets. FIG. 8 illustrates a comparison of free vibration displacement responses with and without longitudinal slits in the VE layer 109 for the CLD. It was discovered that the discontinuity in the VE layer 109 had no significant effect on the damping ratio, as seen in the free displacement vibration responses shown in FIG. 8. In contrast, the constraining layer 106 needs to be continuous in the longitudinal direction of the cylinder to force the VE material to deform in shear. Since in practice the VE material does not easily cover the whole circumference of the HMIP structure, the Abaqus models for the tubular cantilever beam and the HMIP were created by separating both the VE layer 109, as shown in FIG. 9.

Effect of Varying the VE Material Thickness and CLD Coverage. The impact on the performance of the proposed CLD in reducing the vibration response by varying the VE layer thickness and changing the CLD coverage along the prismatic cylindrical cantilever beam was investigated.

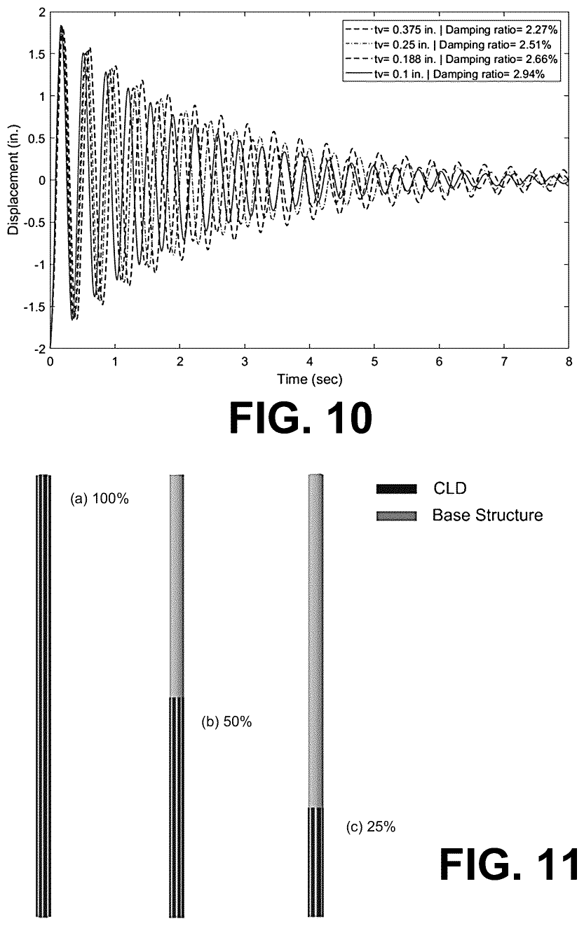

Four different VE layer thicknesses (tᵥ) were chosen based on the manufacturer's datasheet, including 0.1 in., 0.188 in., 0.25 in., and 0.375 in. The four thicknesses were evaluated based on the free vibration response from the implicit step. FIG. 10 illustrates examples of free vibration responses for different VE layer thicknesses (tᵥ). From the simulation results shown in FIG. 10, as the VE layer thickness decreases, the CLD adds higher damping to the structure, which is consistent with previous results. According to the FE analysis, the estimated damping ratios were 2.94%, 2.66%, 2.51%, and 2.27%, respectively, associated with the selected VE layer thicknesses starting with the thinnest layer. The results are also summarized in Table 9.

TABLE 9
Effect of Changing VE Material
Thickness on Tubular Beam's Damping Ratio.

| VE material thickness (in.) | Damping ratio (%) |
|---|---|
| 0.1 | 2.94 |
| 0.188 | 2.66 |
| 0.25 | 2.51 |
| 0.375 | 2.27 |

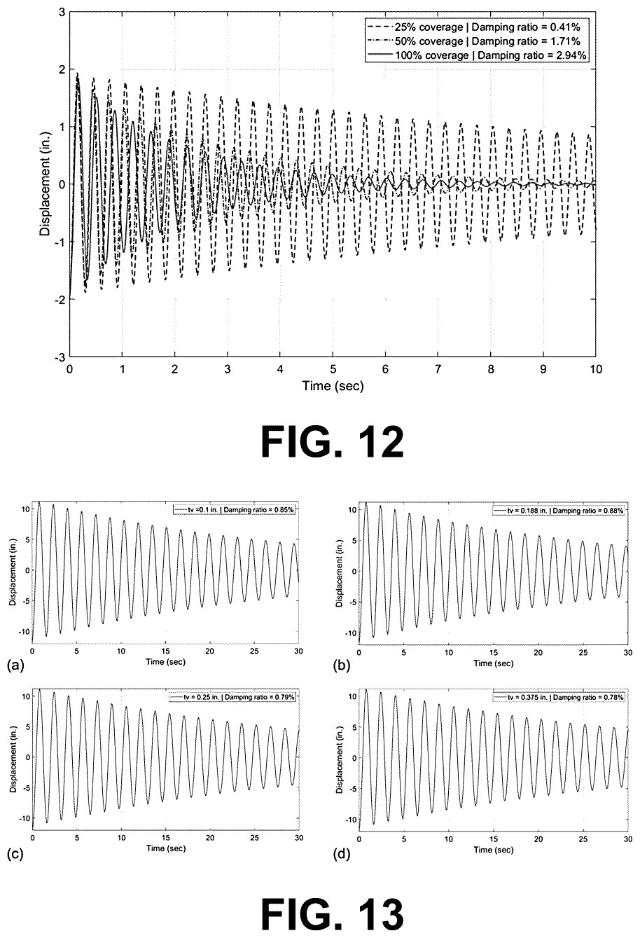

To investigate the impact of the longitudinal coverage of the CLD, the 0.1 in. VE layer thickness was implemented for the CLD, covering (a) 100%, (b) 50%, and (c) 25% of the total height of the tubular beam, as illustrated in FIG. 11. FIG. 12 illustrates examples of free vibration responses for CLD with the 0.1 in. VE layer covering different heights of the beam. The more coverage the CLD has, the better the damper's performance in increasing damping. Specifically, the damping ratio for 100% coverage was 2.94%, 50% coverage was 1.71%, and 25% coverage was 0.41%. Table 10 summarizes the achieved damping ratios based on changing the CLD coverage.

TABLE 10
Effect of Changing CLD Coverage
on Tubular Beam's Damping Ratio.

| CLD coverage (%) | Damping ratio (%) |
|---|---|
| 100 | 2.94 |
| 50 | 1.71 |
| 25 | 0.41 |

A tubular cantilever beam model was used to investigate the behavior of the CLD on a circular hollow section. This model validated the effectiveness of the proposed new CLD design, which includes slits in the longitudinal direction of the constraining layer 106. Introducing the longitudinal slits to the constraining layer 106 allowed an effective development of shear deformation in the VE layer 109 and hence enhanced the damping performance of the system. In addition, results demonstrated that within the considered VE layer thicknesses, thinner VE layers 109 achieved higher damping ratios for the CLD. In addition, the higher percentage of longitudinal coverage of the CLD introduced higher damping to the system. With the above observations, the following will continue to assess the effectiveness of the proposed CLD on the full-scale tapered HMIP structure.

### HMIP Model

A device is presented that can reduce wind-induced vibration on the monitored HMIP. Therefore, the proposed CLD is modeled using Abaqus CAE to cover the bottom 30 ft of the HMIP. The 30-ft coverage of the CLD is determined by a practical height the boom lift can reach, which may be used in installing the CLD in the field. The effect of varying the VE and constraining layer thicknesses on increasing the damping to reduce the vibration amplitude of the HMIP is investigated. A practical adjustment to start the CLD above the HMIP handhole to avoid interference with the handhole is further assessed.

Geometry and Material Properties. Consider an HMIP that is 100 ft tall and is made of galvanized steel with a 0.33-degree tapered hollow circular section. The light assembly weighs 406 lb at the top of the pole, which comprises three LED fixtures and a lowering device. In the FE model, the HMIP can be represented as a single section with a constant thickness of 0.25 in. and a base inner diameter equal to 25 in. Regarding the VE material, the Sorbothane® VE polymer is adopted and is modeled with different thicknesses covering the bottom 30 ft of the pole. Furthermore, the effect of changing the VE layer thickness on the damping ratio will be described later in this section. A type of isotropic CFRP was chosen for the constraining layer 106 due to its unique properties compared to steel sheets, such as lightweight, high stiffness, and ease of handling, cutting, and installation. The material properties of the CFRP are included in Table 11. The effect of changing the thickness of CFRP on the damping ratio is also assessed later in this section. The material properties of steel are listed in Table 1, while the hyperelastic and viscoelastic properties of the Sorbothane® VE material are given in Table 6 and Table 7, respectively.

TABLE 11
CFRP Material Properties.

| Density (lb/in³) | Young's modulus (ksi) | Poisson's ratio |
|---|---|---|
| 0.067 | 33.495 | 0.1 |

Effect of Varying the VE Material Thickness. The effect of changes in the VE layer thickness on the damping ratio of the HMIP were investigated while keeping the CFRP thickness constant and equal to 0.0625 in. The Sorbothane® VE polymer was modeled with four thicknesses: 0.1 in., 0.188 in., 0.25 in., and 0.375 in. The free vibration displacement response was used to estimate the damping ratio obtained for the four VE layer thicknesses.

FIG. 13 illustrates examples of the free vibration displacement response for the HMIP model with constraining layer thickness of ⅙ in. and different VE layer thicknesses including (a) 0.1 in.; (b) 0.188 in.; (c) 0.25 in.; (d) 0.375 in. FIG. 13 shows how the damping performance changes when the VE layer thickness changes. The highest damping ratio was achieved when the VE layer thickness was at 0.188 in., which resulted in 0.88% damping. Increasing or decreasing the VE layer thickness will decrease the damping ratio, which correlates with a previous study. This may be attributed to the fact that decreasing the VE layer thickness leads to higher shear strain in the VE layer, leading to higher energy dissipation. However, if the VE material is too thin, there is not enough VE material to dissipate the vibration energy through shear deformation. Therefore, it is important to consider this competition between the amount of VE material and the level of developed shear strain in selecting the VE layer thickness.

The HMIP's damping ratio obtained from changing the VE material thickness is summarized in Table 12. The damping ratio increases from 0.85% for a VE layer thickness of 0.1 in. to 0.88% when the VE thickness increases to 0.188 in. Then the damping ratio decreases to 0.79% and 0.78% for VE thickness of 0.25 in. and 0.375 in., respectively.

TABLE 12
Effect of Varying VE Material Thickness on
HMIP's Damping Ratio.

| VE material thickness (in.) | Damping ratio (%) |
|---|---|
| 0.1 | 0.85 |
| 0.188 | 0.88 |
| 0.25 | 0.79 |
| 0.375 | 0.78 |

Effect of Varying the CFRP Layer Thickness. The effect of varying the CFRP thickness on vibration reduction performance was examined while maintaining the VE layer thickness at 0.1 in. The VE layer thickness was chosen to be 0.1 in. because of its excellent damping performance without using too much VE material. The CFRP was modeled with four different thicknesses: 0.0625 in., 0.08 in., 0.1 in., and 0.125 in. The reduction of the displacement amplitude was assessed to determine the damping ratio to evaluate the impact of the CFRP thickness.

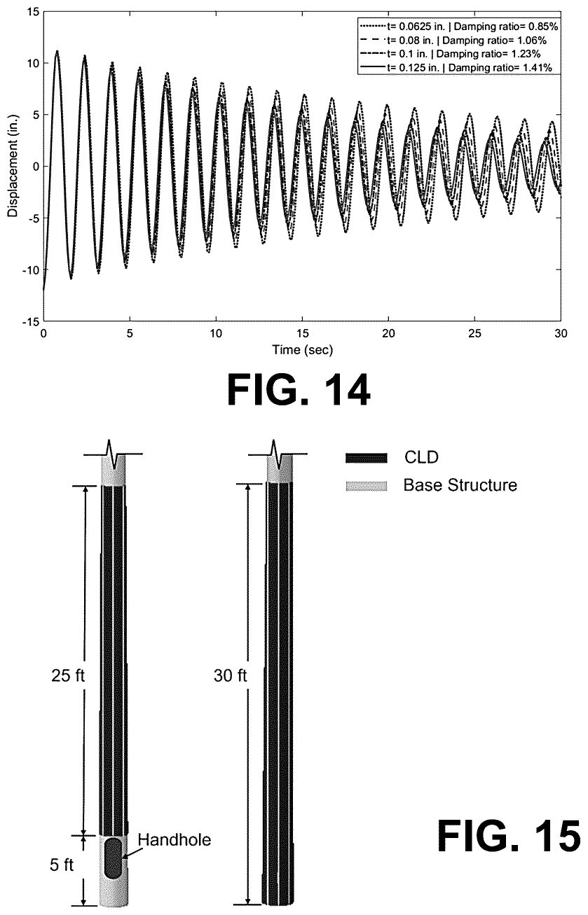

FIG. 14 illustrates examples of free vibration displacement response for the HMIP model with varying CFRP thicknesses while fixing the VE layer thickness to 0.1 in. It is noted from the free vibration response shown in FIG. 14 that increasing the thickness of the CFRP leads to better damping performance with the CLD. The maximum obtained damping ratio is 1.41% for the CFRP thickness of 0.125 in., and the damping ratios are 1.23%, 1.06%, and 0.85% for CFRP thicknesses of 0.1 in., 0.08 in., and 0.0625 in., respectively. Table 13 summarizes the HMIP damping ratios corresponding to different CFRP thicknesses.

TABLE 13
Effect of Varying CFRP Thickness
on HMIP's Damping Ratio.

| CFRP thickness (in.) | Damping ratio (%) |
|---|---|
| 0.0625 | 0.85 |
| 0.08 | 1.06 |
| 0.1 | 1.23 |
| 0.125 | 1.41 |

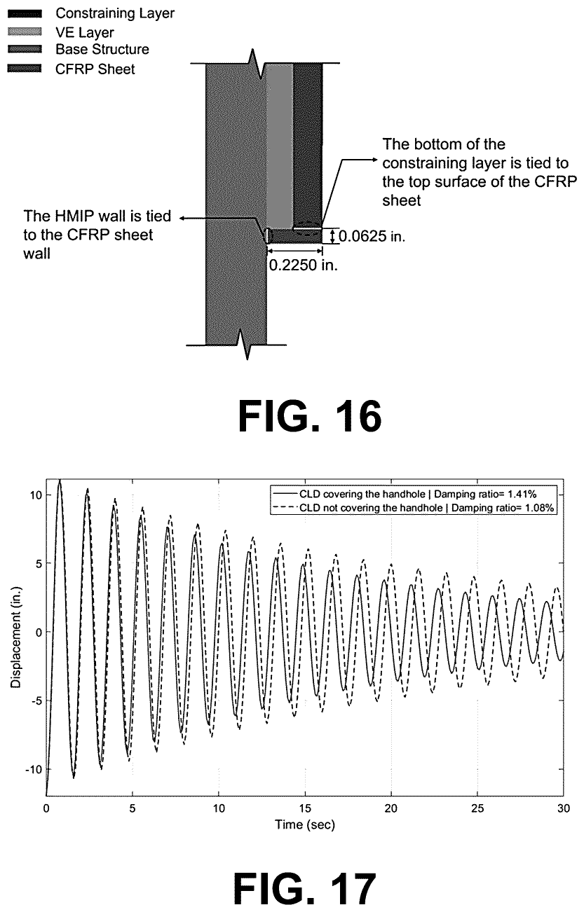

Effect of a Practical Adjustment to the CLD. The effect of adjusting the CLD to start above the HMIP's handhole to avoid interference between the CLD and the handhole was studied. FIG. 15 illustrates the CLD applied to the HMIP in the FE model (a) with the CLD not covering the handhole and (b) the CLD covering the handhole. Here, the CLD started 5 ft above the ground to avoid covering the handhole, and its total length became 25 ft instead of 30 ft. Meanwhile, the VE layer thickness was selected as 0.1 in., and the constraining layer 106 is 0.125 in. thick, anchored at the bottom of the HMIP structure. In the FE model, the constraining layer 106 was anchored to the HMIP using a thin CFRP sheet with a thickness of 0.0625 in. and a length of 0.225 in. covering the area beneath the constraining and VE material. FIG. 16 illustrates the detail in the FE model for anchoring the constraining layer 106 to the HMIP. As shown in FIG. 16, the anchorage was made by tying the HMIP's wall to the CFRP sheet wall and tying the bottom of the constraining layer to the top surface of the sheet. This arrangement was made to simulate anchoring the constraining layer 106 to the HMIP only for the FE model.

FIG. 17 illustrates examples of free vibration displacement response for the proposed CLD and the adjusted CLD. FIG. 17 compares the free vibration responses between the HMIPs with CLD starting from the base plate and one starting above the handhole. The plot demonstrates that adjusting the CLD to avoid covering the handhole reduced the damping ratio compared to when the constraining layer was anchored to the base of the HMIP. The reduction in the damping ratio may be attributed to the loss of some CLD coverage. However, the damping ratio reduces from 1.41% to 1.08%, which is not a huge reduction. Moreover, the damping ratio introduced by the adjusted CLD is still higher than the HMIP's inherent damping, which is 0.8% as determined by the pluck test. As a result, after retrofitting the HMIP, the adjusted CLD will increase the structure's total damping ratio to 1.88%, which is 235% of the inherent structural damping.

Steady-State Response for the HMIP at Resonance. Because the wind loading becomes a concern when it triggers resonance at the first mode due to buffeting, the steady-state response of the HMIP under the first mode resonance under three scenarios was evaluated, including 1) no CLD is used, 2) the adjusted CLD which starts above the handhole is implemented, and 3) the CLD that starts from the base plate and covers the HMIP handhole. This assessment provided a better understanding of how the previously achieved damping ratios would reduce the steady-state vibration response under the first-mode resonance produced by wind-induced buffeting.

The steady-state response reflected the amplitude and phase angle of the harmonic vibration of a single-degree-of-freedom (SDOF) system as a result of a harmonic load excitation, and it is given as uₚ=U cos(Ωt−α), where U is the vibration amplitude, Ω is the excitation frequency, and α is the phase angle. Based on structural dynamics, the dimensionless amplitude of the steady-state response [symbol] (r) is given by:

$$\overline{H} ( r ) = \frac{U}{{U}_{0}} = \frac{1}{\sqrt{{( 1 - {r}^{2} )}^{2} + {( 2 ζ r )}^{2}}} \qquad ( 8 )$$

where U₀ is the static displacement and is defined as the displacement the mass would experience if the force were applied statically. r is the ratio of the excitation frequency (Ω) over the natural frequency (ωₙ), and at resonance r is equal to 1. Hence, the dimensionless amplitude of the steady-state response at resonance is given by:

$$\overline{H} ( r ) = \frac{1}{2 ζ} . \qquad ( 9 )$$

The damping of the HMIP structure was determined to be 0.8%, while installing the adjusted CLD, which starts above the handhole, resulted in an overall damping ratio of around 1.88%. When the CLD was extended to the HMIP's base, the estimated overall damping ratio was 2.22%. Since the amplitude of the vibration at resonance is inversely proportional to the damping ratio, as shown in Equation (9), the adjusted CLD would reduce the vibration amplitude by 57.4%, while the CLD that covers the handhole would reduce the vibration amplitude by 64% compared with the vibration response of the bare HMIP structure. Table 14 summarizes the dimensionless amplitudes of the steady-state responses at the first mode resonance of the HMIP.

TABLE 14
The Dimensionless Amplitude of Steady-State Response at
HMIP's First Mode Resonance for Three CLD Scenarios

| | | Reduction from |
|---|---|---|
| Scenario | H̅(r = 1) | no CLD case |
| No CLD | 62.5 | 0% |
| CLD is not covering the handhole | 26.6 | 57.4% |
| CLD is covering the handhole | 22.5 | 64% |

The proposed CLD design was tested on the HMIP structure to reduce the wind-induced vibration due to buffeting. The CLD coverage was set to 30 ft, and the free vibration was assessed by varying the thickness of the VE and CFRP layers 109 and 106. It was found that the optimal thickness for the VE material was 0.188 in. The damping ratio increased until the VE layer thickness reached 0.188 in. and then started to decrease as the thickness increased. Regarding the CFRP thickness, the damping ratio was positively correlated with the thickness of CFRP. In addition, adjusting the CLD to avoid the handhole reduced the damping ratio compared to the case when the CLD started from the base of the HMIP. Nonetheless, even when the CLD started above the handhole, it increased the total damping of the HMIP to 235% of its inherent structural damping. Furthermore, looking at the dimensionless steady-state amplitude at the HMIP's first mode resonance for three different cases, including no CLD, adjusted CLD that avoids the handhole, and the CLD that starts from the HMIP's base, it was found that the adjusted CLD would reduce the steady-state amplitude at first mode resonance by 57.4% compared with the bare structure, while the CLD that covers the handhole would reduce the steady-state amplitude by 64%.

This disclosure numerically investigated the use of CLD to reduce the vibration due to wind-induced buffeting on HMIPs. First, conventional CLD on tubular structures was assessed and it was found that the traditional method of adding one continuous constraining layer around the cylindrical structure was ineffective in reducing the vibration due to the overlapping neutral axes between the base structure 103 and the constraining layer 106. As a result, a new CLD design was proposed by adding multiple slits to the constraining layer 106 to divide it into pieces and separate the neutral axis of the base structure 103 from those of the constraining layer pieces. The proposed CLD design allows each piece of the constraining layer 106 to move independently from others when the base structure 103 undergoes bending deformation. Hence, the proposed CLD allows the VE layer 109 to fully engage in shear deformation to dissipate energy for vibration mitigation.

The disclosure then investigated the selection of VE material by assessing the damping ratio from CLDs that adopt three different VE materials based on the rectangular cantilever beam model. It was found that Sorbothane® VE polymer achieved a higher damping ratio compared with the HDR and the vulcanized natural rubber. Therefore, the Sorbothane® VE material was used for the rest of the numerical investigations.

Subsequently, the conventional and proposed CLDs were compared in terms of the shear strain distribution along the VE layer 109 based on the prismatic tubular cantilever beam. In the conventional CLD, it was found that the shear strain distribution along the VE material was negligible. On the other hand, the proposed CLD allowed the shear strain to accumulate towards the VE layer's free end, resulting in a damped free vibration response. In addition, the parametric study based on the tubular cantilever beam found that within the considered VE material thicknesses, thinner VE materials generated a higher damping ratio. The study also assessed the longitudinal coverage of the CLD and found that more coverage of the CLD leads to higher damping.

After verifying the ability of the proposed CLD to dampen the vibration on tubular structures, the effectiveness of the proposed CLD in reducing buffeting-induced vibration on HMIP structures was further examined. Covering the bottom 30 ft of the 100-ft tall HMIP added a 1.41% damping ratio to the 0.8% inherent damping of the HMIP, leading to an overall damping of 2.21%. Then, a practical adjustment for the CLD to start above the handhole introduced a 1.08% damping ratio to the HMIP, leading to an overall damping of 1.88%, which is 235% of the HMIP's inherent damping. Finally, the dimensionless steady-state response amplitude under the first mode resonance of the HMIP was assessed. It was found that the adjusted CLD that starts above the handhole reduced the vibration amplitude by 57.4%, while the CLD that covers the handhole reduced the amplitude by 64% compared to the no CLD case. Overall, the proposed CLD design has shown to be a promising solution for reducing buffeting-induced vibration on HMIPs.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A structure, comprising:
a tubular base structure extending along a longitudinal axis;
a viscoelastic (VE) layer disposed on and distributed about the tubular base structure; and
a constraining layer comprising a plurality of sections distributed about the tubular base structure and disposed on the VE layer, each section extending along the longitudinal axis of the tubular base structure and separated from an adjacent section by a longitudinal slit extending over an entire length of the section.

2. The structure of claim 1, wherein the tubular base structure comprises steel.

3. The structure of claim 1, wherein the structure is a high mast illumination pole.

4. The structure of claim 1, wherein the VE layer comprises a rubberized material.

5. The structure of claim 4, wherein the rubberized material is a vulcanized natural rubber, a high-damping rubber, or a viscoelastic polymer.

6. The structure of claim 5, wherein the viscoelastic polymer is a synthetic viscoelastic urethane polymer.

7. The structure of claim 1, wherein the plurality of sections comprise sheet steel.

8. The structure of claim 1, wherein the plurality of sections comprise carbon fiber reinforced polymer (CFRP).

9. The structure of claim 1, wherein the tubular base structure is a tapered tubular structure.

10. The structure of claim 1, wherein the tubular base structure is a prismatic tubular structure.

11. The structure of claim 1, wherein the plurality of sections consist of eight sections.

12. The structure of claim 1, wherein the plurality of sections consist of an even number of sections or an odd number of sections.

13. A method, comprising:
disposing a viscoelastic (VE) layer on a tubular base structure extending along a longitudinal axis, the VE layer distributed about the tubular base structure; and
disposing a constraining layer on the VE layer, the constraining layer comprising a plurality of sections distributed about the longitudinal axis of the tubular base structure, each section extending along the longitudinal axis of the tubular base structure and separated from an adjacent section by a longitudinal slit extending over an entire length of the section.

14. The method of claim 13, wherein the plurality of sections consists of eight sections.

15. The method of claim 13, wherein the tubular base structure comprises steel.

16. The method of claim 13, wherein the VE layer comprises a rubberized material.

17. The method of claim 16, wherein the rubberized material is a vulcanized natural rubber, a high-damping rubber, or a viscoelastic polymer.

18. The method of claim 13, wherein the plurality of sections comprise either sheet steel or carbon fiber reinforced polymer (CFRP).

19. The method of claim of 13, wherein the tubular base structure is a tapered tubular structure or a prismatic tubular structure.

20. The method of claim 13, wherein the VE layer and the constraining layer are distributed beginning at a defined distance from a base of the tubular structure.
